(19) United States
(12) Patent Application Publication
(10) Pub. No.: US 2006/0185551 A1
(43) Pub. Date: Aug. 24, 2006

(54) Reel changer for a web-fed press and method for regulating a reel change

(75) Inventors: Bernd Mehlis, Plauen (DE); Raimond Posselt, Reichenbach (DE); Markus Scharf, Plauen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/358,447

(22) Filed: Feb. 21, 2006

(30) Foreign Application Priority Data
Feb. 22, 2005 (DE) 10 2005 008 223.8

(51) Int. Cl. B41F 33/00

(52) U.S. Cl. 101/484

(57) ABSTRACT

A method for regulating a reel changer of a web-fed press includes having a current controller and a rotational speed controller connected to the current controller as a cascade control, and a position controller for positioning a dancer roller connected to the rotational speed controller to effect a further cascade. The method includes deactivating the position controller of the dancer roll and feeding a differentiated set point of the rotational speed controller to the output variable of the rotational speed controller as a feedforward control component during a reel change and, after the reel change has been performed, activating the position controller of the dancer roll and feeding a differentiated actual value of the position controller to the output variable of the rotational speed controller as a feedforward control component.

### BACKGROUND OF THE INVENTION

The present invention relates to a reel changer for a web-fed press and a method for regulating the reel changer of the web-fed press.

Reel changers of web-fed presses primarily perform three main tasks: unwinding a printing material web from a reel of printing material at a defined web speed; applying a defined web tension to the printing material web to be unwound; and executing a reel change between a printing material reel that is running out and a new printing material reel. Reel changers may also be referred to as reel carriers. As the printing material web is unwound from the printing material reel, the maintenance of the defined web speed and the application of the defined web tension are of primary importance. If a reel change between a printing material reel that is running out and a new printing material reel is to be carried out, then the new printing material reel must be accelerated to the circumferential speed of the printing material reel that is running out, to synchronize the web speeds of the respective printing material webs.

The maintenance of a defined web speed and also a defined web tension of the printing material web to be unwound from the printing material reel, and also the acceleration of a new printing material reel to the circumferential speed of a printing material reel that is running out, is carried out during the reel change using a regulation method.

It is already known from practice to use a cascade control loop comprising a current controller and a rotational speed controller superimposed on the current controller to regulate the rotational speed of a motor driving a printing material reel and therefore to regulate the circumferential speed of the printing material reel and the web speed of the printing material web to be unwound. Furthermore, it is known from practice to provide the defined web tension using a dancer roll which presses with a defined force into a loop of the printing material web unwound from the printing material reel. In this case, the dancer roll is to be kept in a central position by a position controller. That is, the web speed of the printing material before or upstream of the dancer roll is to correspond to the web speed of the printing material web after or downstream of the dancer roll. To this end, a position controller which keeps the dancer roll in the defined central position is superimposed on the cascade control loop comprising the current controller and rotational speed controller, with the effect of a further cascade.

The above control concept known from the prior art for a reel changer tends to oscillate, which has a detrimental effect on the quality of control. One reason for the oscillation is that both the printing material reel and the dancer roll include an integral control response, which can ultimately lead to control oscillations.

### SUMMARY OF THE INVENTION

An object of the present invention is to provide a method for regulating a reel changer for a web-fed press and a reel changer which overcomes the problems of the prior art.

The object is met by a method for controlling a reel changer of a web-fed press which includes, during a reel change, deactivating a position controller of a dancer roller to synchronize a circumferential speed of a new printing material reel with the circumferential speed of the printing material reel that is running out, and feeding a differentiated set point of a rotational speed controller to an output variable of the rotational speed controller as a feedforward control component to form a set point of a current controller. After the reel change has been effected, the position controller of the dancer roll is activated in the course of or during unwinding of the printing material web and a differentiated actual value of the position controller is fed forward to the output variable of the rotational speed controller as a feedforward control component to form the set point of the current controller.

During a reel change and with the position controller of the dancer roll deactivated, the time differential of the set point of the rotational speed controller is used as a feedforward component when forming the set point for the current controller of the cascade control loop comprising current controller and rotational speed controller. After the reel change has been effected, when the position controller of the dancer roll activated, the time differential of the actual value of the position controller is used as a feedforward component when forming the set point of the current controller. In this case, both during the reel change and after the reel change has been carried out, control oscillations can be counteracted, which means that a good control behaviour is achieved. Furthermore, a robust control behaviour can be implemented, which is unaffected by mismatching between the motor and printing material reel, such as can occur in the case of large printing material reels. In the case of large mass inertia values of the printing material reels, it is possible to use relatively small motors with low output. This is a further, economic advantage of the method according to the invention.

The reel changer according to the invention of a web-fed press includes a controller for implementing the above method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention, without being restricted thereto, will be explained in more detail by using the drawing, in which:

FIG. 1 is a block diagram illustrating the method according to the present invention for regulating a reel changer of a web-fed press.

### DETAILED DESCRIPTION OF THE PRESENTLY PREFERRED EMBODIMENTS

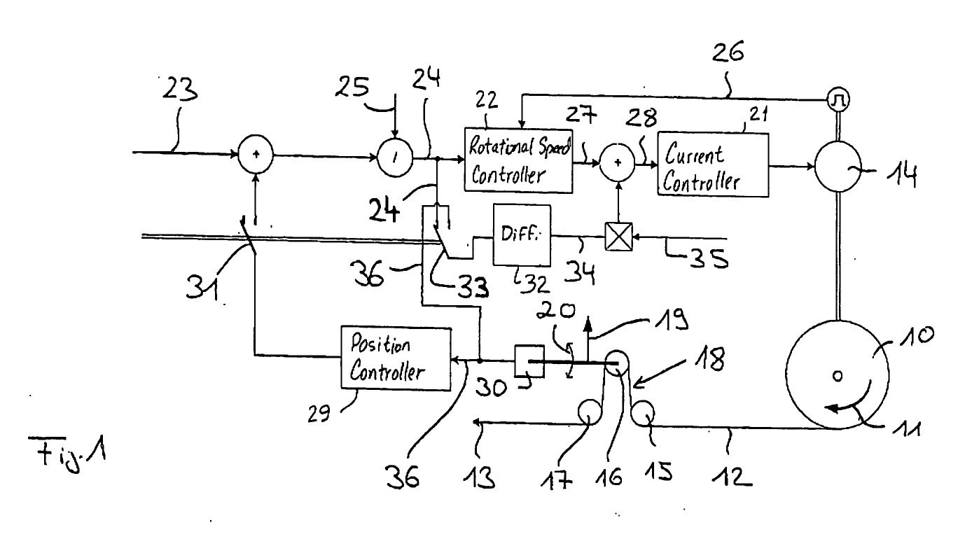

FIG. 1 shows a block diagram of a control structure according to the invention for a reel changer of a web-fed rotary press. According to FIG. 1, a printing material web 12 is unwound from a printing material reel 10 in the direction of the arrow 11 and is fed to a web-fed rotary press in the direction of the arrow 13. The printing material reel 10 is mounted on a reel changer (not illustrated in detail). A reel changer may also be referred to as a reel carrier. The printing material reel 10 is driven by a motor 14, it being possible for the circumferential speed of the printing material reel 10 and therefore the web speed of the printing material web 12 to be unwound to be calculated from the rotational speed of the motor 14 and the radius or diameter of the printing material reel 10. Since the radius of the printing material reel 10 changes as the printing material web 12 is unwound, the rotational speed of the motor 14 has to be adapted continuously to maintain a constant web speed.

The printing material web 12 unwound from the printing material reel 10 is led to rolls 15, 16 and 17 and forms a loop 18. The rolls 15 and 17 are deflection rolls and the roll 16 is a dancer roll which presses into the loop 18 with a defined force in the direction of the arrow 19 to provide a defined web tension. The web speed of the printing material web 12 is to be exactly as large before or upstream of the dancer roll 16 and after or downstream of the dancer roll 16. If this is the case, then the dancer roll 16 is in the central position illustrated in FIG. 1. If, however, a differential speed of the web 12 occurs at the dancer roll 16, then the dancer roll 16 will be deflected either upwards or downwards in the direction of the double arrow 20 as compared with the central position to eliminate the differential. Deflection of the dancer roll 16 is to be avoided for optimal performance.

The aim of the control structure illustrated in FIG. 1 is to unwind the printing material web 12 from the printing material reel 10 at a defined web speed and, in the process, to keep the dancer roll 16 in its central position, so that no differential speed occurs at the dancer roll 16, which produces the web tension on the printing material web 12.

To regulate the circumferential speed of the printing material reel 10 and therefore the web speed of the printing material web 12, the rotational speed of the motor 14 driving the printing material web 10 is regulated with the aid of a cascade control loop comprising a current controller 21 and a rotational speed controller 22 superimposed on the current controller 21. According to FIG. 1, a set point 23 for the web speed of the printing material web 12 and therefore for the circumferential speed of the printing material reel 10 is predefined. A calculation is performed with the set point 23 and an auxiliary variable 25 to provide a set point 24 for the rotational speed controller 22 of the motor 14. The auxiliary variable 25 is the diameter of the printing material reel 10 which, as already mentioned, changes continuously as the printing material web 12 is unwound from the printing material reel 10. The rotational speed controller 22 uses the set point 24 and an actual value 26 of the motor rotational speed registered on the motor 14 to provide an output variable 27 from which the set point 28 for the current controller 21 is generated or determined.

A position controller 29 for the dancer roll 16 is superimposed on the cascade control loop comprising the current controller 21 and the rotational speed controller 22, with the effect of a further cascade. With the aid of the position controller 29, the dancer roll 16, which is used to provide a defined web tension, is kept in its central position, so that accordingly, no differential speed occurs at the dancer roll 16. The web speed before the dancer roll 16 is therefore intended to be exactly as large as the web speed after the dancer roll 16. To this end, the position of the dancer roll 16 is monitored with the aid of a sensor 30, and a corresponding actual value 36 is supplied to the position controller 29.

Current controller 21 and rotational speed controller 22 are preferably implemented as PI controllers. The position controller 29, on the other hand, is preferably implemented as a PID controller. The I term of the position controller 29 ensures that, even when there is an erroneous auxiliary variable 25, that is to say when the diameter of the printing material reel 10 is determined incorrectly, an exact central position of the dancer roll 16 is maintained.

According to FIG. 1, the position controller 29 of the dancer roll 16 can be activated and deactivated by a switch 31. To effect a reel change, the position controller 29 of the dancer roll 16 is deactivated. The position controller 29 is subsequently activated after the reel change has been effected. FIG. 1 shows the control structure with the switch 31 open, i.e., in a state present for performing a reel change.

During a reel change or to carry out a reel change, the time differential of the set point 24 of the rotational speed controller 22 is fed forward to the output variable 27 of the rotational speed controller 22 to form the set point 28 for the current controller 21. Thus, FIG. 1 shows a differential element 32 connected to a switch 33. During a reel change, the switch 33 is positioned so that the set point 24 of the rotational speed controller 22 is fed as input variable to the differential element 32. In this position of the switch 33, an output variable 34 of the differential element 32 is a time differential of the set point 24 of the rotational speed controller 22. The output variable 34 is multiplied with an auxiliary variable 35 and then added to the output variable 27 of the rotational speed controller 22 to form the set point 28 of the current controller 21. The auxiliary variable 35 is the cube of the radius of the printing material reel 10 multiplied by the reel width of the same.

To perform a reel change and to synchronize the circumferential speed of a new printing material reel with the circumferential speed of the printing material reel that is running out, the position controller 29 of the dancer roll 16 deactivated. In addition, the rotational speed controller 22 of the motor 14 is relieved of load by providing a feedforward component to the current controller 21. The feedforward component being the time differential of the set point 24 of the rotational speed controller 22. In this way, instantaneous feedforward is provided during the reel change, so that a change in the speed of the press or a set point ramp can be fed forward relatively exactly during the synchronization of the circumferential speed of new printing material reel with printing material reel running out, by which means a tendency to oscillation is counteracted.

After the reel change has been performed, the control strategy is changed by the switching the position of switches 31 and 33. More specifically, switch 31 is closed to activate the position controller 29 of the dancer roll 16 and switch 33 changes the feedforward component that is fed to the set point 28 of the current controller 21.

After the reel change has been performed, switch 33 is switched to a position in which the time differential of the output variable 36 from the sensor 30 is specifically provided as feedforward component for the current controller 21. The output variable 36 from the sensor 30 is the actual value of the position of the dancer roll 16 which is fed to the position controller 29. Accordingly, after the reel change has been performed, the differentiated actual value 36 is fed forward to the output variable 27 of the rotational speed controller 22 as feed forward component to form the set point 28 of the current controller 21 with the position controller 29 activated. The output signal 34 provided by the differentiation element 32 is also multiplied with the auxiliary variable 35 in this state, which is the cube of the radius of the printing material reel multiplied by the reel width of the same.

As a result of the changeover according to the invention of the feedforward component to the time differential of the position signal of the dancer roll after the reel change has been performed, the tendency of the dancer roll to oscillate is reduced. In this way, the dancer roll having the control response according to the present invention is excited to considerably fewer control oscillations. Furthermore, the robustness of the controller with respect to parameter inaccuracies or parameter errors in the control loop and with respect to possible disturbance variables rises.

In conclusion, it should be pointed out that the method according to the invention can be used not only when unwinding a printing material web from a printing material reel but, in an analogous way, also during winding or rewinding.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for regulating a reel changer of a web-fed press, the reel changer having a motor driving a printing material reel with a printing material web, a cascade control loop for regulating the rotational speed of the motor and therefore the circumferential speed of the printing material reel and the web speed of the printing material web to be unwound from the printing material reel, the cascade control loop comprising a current controller and a rotational speed controller superimposed on the current controller, the rotational speed controller outputting an output variable, and a position controller superimposed on the cascade control loop effecting a further cascade, the position controller controlling a position of a dancer roll acting on the unwound printing material web to provide a defined web tension, said method comprising the steps of:
during a reel change, deactivating the position controller of the dancer roll to synchronize the circumferential speed of a new printing material reel with the circumferential speed of the printing material reel that is running out, and feeding a differentiated set point of the rotational speed controller to the output variable of the rotational speed controller as a feedforward control component, wherein the differentiated set point and the output variable form a set point of the current controller; and
after the reel change has been performed, activating the position controller of the dancer roll and feeding a differentiated actual value of the position controller to the output variable of the rotational speed controller as a feedforward control component to form the set point of the current controller.

2. The method of claim 1, wherein during the reel change, the differentiated set point of the rotational speed controller is a time differential of the set point of the rotational speed controller.

3. The method of claim 1, wherein during the reel change, the differentiated set point of the rotational speed controller is calculated with the cube of a radius of the printing material reel and a reel width of the printing material reel, before the differentiated set point of the rotational speed controller is fed forward to the output variable of the rotational speed controller.

4. The method of claim 1, wherein after the reel change has been performed, the differentiated actual value of the position controller fed forward to the output variable of the rotational speed controller is a time differential of the actual value of the position controller.

5. The method of claim 1, wherein after the reel change has been performed, the differentiated actual value of the position controller is calculated with the cube of a radius of the printing material reel and a reel width of the printing material reel before the differentiated actual value of the position controller is fed forward to the output variable of the rotational speed controller.

6. A reel changer for a web-fed press, comprising:
a motor driving a printing material reel with a printing material web;
a cascade control loop regulating the rotational speed of the motor and therefore the circumferential speed of the printing material reel and the web speed of the printing material web to be unwound from the printing material reel, the cascade control loop comprising a current controller and a rotational speed controller superimposed on the current controller, the rotational speed controller outputting an output variable;
a position controller superimposed on the cascade control loop effecting a further cascade, the position controller controlling a position of a dancer roll acting on the unwound printing material web to provide a defined web tension;
a first switch arranged for deactivating said position controller during a reel change by disconnecting said position controller from said cascade control loop and activating sais position controller after the reel change is performed by connecting said position controller to said cascade control loop; and
a second switch arranged for selectively connecting a differentiated set point of the rotational speed controller to the output variable of the rotational speed controller as a feedforward control component during a reel change and connecting a differentiated actual value of the position controller to the output variable of the rotational speed controller as a feedforward control component after the reel change is performed.
